(19) United States
(12) Patent Application Publication
(10) Pub. No.: US 2025/0095084 A1
(43) Pub. Date: Mar. 20, 2025

(54) METHOD AND SYSTEM FOR SPATIAL-ECONOMIC ANALYSIS OF AGRICULTURAL FIELDS

(71) Applicant: ADVANCED AGRILYTICS HOLDINGS, LLC, Indianapolis, IN (US)

(72) Inventors: William Kess Berg, Clayton, IN (US); Jon J. Fridgen, Lancaster, KY (US)

(21) Appl. No.: 18/969,169

(22) Filed: Dec. 4, 2024

Related U.S. Application Data
(63) Continuation of application No. 17/480,099, filed on Sep. 20, 2021, now abandoned.
(60) Provisional application No. 63/080,966, filed on Sep. 21, 2020.

(51) Int. Cl. G06Q 50/02; G06Q 10/0631; G06Q 10/0637

(52) U.S. Cl. CPC G06Q 50/02; G06Q 10/06313; G06Q 10/06375

(57) ABSTRACT

A method for providing a high-resolution economic analysis of a partitioned agricultural field includes partitioning the field, measuring agricultural inputs, receiving market data, computing gross revenue, agricultural yield and net revenue; and generating an economic analysis report for each cell. A computing system includes a processor and memory storing instructions that when executed by the processor cause the computing system to partition the field, receive market data, measure agricultural inputs, compute gross revenue, agricultural yield and net revenue; and generate an economic analysis report for each cell. A non-transitory computer readable medium includes program instructions that when executed, cause a computer to partition the field, receive market data measure agricultural inputs, compute gross revenue, agricultural yield and net revenue; and generate an economic analysis report for each cell.

### CROSS-REFERENCE TO RELATED APPLICATIONS

This application is a continuation of U.S. patent application Ser. No. 17/480,099, filed Sep. 20, 2021, and entitled METHOD AND SYSTEM FOR SPATIAL-ECONOMIC ANALYSIS OF AGRICULTURAL FIELDS, which claims priority to U.S. Provisional Application No. 63/080,966, filed Sep. 21, 2020, and entitled METHOD AND SYSTEM FOR SPATIAL-ECONOMIC ANALYSIS OF AGRICULTURAL FIELDS, which is incorporated herein by reference in its entirety.

### FIELD OF THE DISCLOSURE

The present disclosure is generally directed to methods and systems for performing a spatial-economic analysis of an agricultural field, and more specifically, for providing a high-resolution economic analysis of a partitioned agricultural field.

### BACKGROUND

Field profitability is generally measured at a high level in conventional techniques. As such, growers, field managers, trusted advisors and other key decision-makers lack insight into field performance. For example, the grower may not understand why two fields that appear similar have very divergent economic profitability.

Measuring yield at the field level does not provide the grower, field manager or trusted advisor with actionable information. In particular, the lack of specificity in existing techniques does not allow the knowledgeable grower to spot patterns with respect to the field that may be unrelated to agricultural inputs.

The conventional lack of granularity also makes it impossible for a first grower to compare field profitability with a second grower. Furthermore, conventional field profitability analyses may not take into account indirect costs to the grower beyond the agricultural inputs that are necessary for the growing of a crop.

### BRIEF SUMMARY

In one aspect, a computer-implemented method for providing a high-resolution economic analysis of a partitioned agricultural field includes partitioning, via one or more processors, the agricultural field into hexagonal grid cells; measuring, via one or more processors, a set of agricultural inputs for each of the respective grid cells, wherein the set of agricultural inputs includes both direct costs and indirect costs; receiving, via one or more processors, market data corresponding to a crop planted on the agricultural field; computing, via one or more processors, an agricultural yield for each of the respective grid cells; computing, via one or more processors, a gross revenue for each of the respective grid cells by analyzing a respective cost of each of the agricultural inputs, the market data and the respective agricultural yield of each of the respective grid cells; computing, via one or more processors, a net revenue for each of the respective grid cells by subtracting at least the direct costs and the indirect costs from the respective gross revenue; in response to receiving a user selection of one or more of the grid cells via a graphical user interface, generating, via one or more processors, an analysis report including the gross revenue, the agricultural yield, and the net revenue for each of the respective selected grid cells, wherein the generating includes processing the respective selected grid cells using a machine learning model trained using labeled yield data and revenue data to generate one or more recommendations, each corresponding to a respective one of the respective grid cells; and transmitting the analysis report to a computing device for display to the user, wherein the analysis report includes recommendations for adding or subtracting one or more agricultural inputs based on the net revenue and as-applied data of the respective grid cells.

In another aspect, a computing system includes a processor and a memory storing instructions that, when executed by the processor, cause the computing system to partition the agricultural field into hexagonal grid cells; measure a set of agricultural inputs for each of the respective grid cells, wherein the set of agricultural inputs includes both direct costs and indirect costs; receive market data corresponding to a crop planted on the agricultural field; compute an agricultural yield for each of the respective grid cells; compute a gross revenue for each of the respective grid cells by analyzing a respective cost of each of the agricultural inputs, the market data and the respective agricultural yield of each of the respective grid cells; compute a net revenue for each of the respective grid cells by subtracting at least the direct costs and the indirect costs from the respective gross revenue; generate an analysis report including the gross revenue, the agricultural yield, and the net revenue for each of the respective selected grid cells by processing the respective selected grid cells using a machine learning model trained using labeled yield data and revenue data to generate one or more recommendations, each corresponding to a respective one of the respective grid cells; and transmit the analysis report to a computing device for display to the user, wherein the analysis report includes recommendations for adding or subtracting one or more agricultural inputs based on the net revenue and as-applied data of the respective grid cells.

In yet another aspect, a non-transitory computer readable medium includes program instructions that when executed, cause a computer to partition the agricultural field into hexagonal grid cells; measure a set of agricultural inputs for each of the respective grid cells, wherein the set of agricultural inputs includes both direct costs and indirect costs; receive market data corresponding to a crop planted on the agricultural field; compute an agricultural yield for each of the respective grid cells; compute a gross revenue for each of the respective grid cells by analyzing a respective cost of each of the agricultural inputs, the market data and the respective agricultural yield of each of the respective grid cells; compute a net revenue for each of the respective grid cells by subtracting at least the direct costs and the indirect costs from the respective gross revenue; generate an analysis report including the gross revenue, the agricultural yield, and the net revenue for each of the respective selected grid cells by processing the respective selected grid cells using a machine learning model trained using labeled yield data and revenue data to generate one or more recommendations, each corresponding to a respective one of the respective grid cells; and transmit the analysis report to a computing device for display to the user, wherein the analysis report includes recommendations for adding or subtracting one or more agricultural inputs based on the net revenue and as-applied data of the respective grid cells.

### BRIEF DESCRIPTION OF THE DRAWINGS

The figures described below depict various aspects of the system and methods disclosed therein. It should be understood that each figure depicts one embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts an exemplary computing environment for providing a high-resolution economic analysis of a partitioned agricultural field, according to one embodiment.

FIG. 2 depicts an exemplary environment depicting partitioning of an agricultural field into a partitioned field using a plurality of hexagonal grid cells, or hexagrids, and as-applied data standardization according to an embodiment.

FIG. 3 depicts an exemplary combination data flow and block diagram depicting collecting agricultural inputs with respect to a hexagrid, according to an embodiment.

FIG. 4 depicts an exemplary graphical user interface including a partitioned field, subdivided into hexagrid cells denoting economic profitability, according to one embodiment.

FIG. 5 depicts an exemplary computer-implemented method for providing a high-resolution economic analysis of a partitioned agricultural field, according to one embodiment and scenario.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

### Overview

The present disclosure is generally directed to methods and systems for performing a spatial-economic analysis of an agricultural field, and more specifically, for providing a high-resolution economic analysis of a partitioned agricultural field.

The present techniques may include providing field owners, growers and/or trusted advisors with economic analyses with respect to agricultural inputs and yields, both at a granular level (e.g., at a hexagrid level) and/or with respect to an entire field, or group of fields. In other words, the present techniques may be used to identify hexagrids that are profitable, break-even or resulting in a loss. The identified profitability of hexagrids may be aggregated and used as a proxy to represent field profitability. Field profitability may be aggregated to measure the profitability of a grower's entire operation, in some embodiments.

Measuring economic inputs in the context of the present techniques includes analyzing any economic cost to a given hexagrid, including the per-hexagrid costs of treatments (e.g., amount of nitrogen, amount of fungicide, etc.), seed, etc. The respective cost of each unit of input may be predetermined and thus the total input per hexagrid calculated by multiplying the amount of the input used by the per-unit cost.

As-applied data may include historical records (e.g., log files) denoting how much of each treatment was applied to a given hexagrid. As-applied data may be retrieved from a module of a farming implement, as described below. As-applied data may be included in machine data that may include other information used to calculate costs (e.g., fuel consumption, miles driven, etc.). Additional economic inputs that may be counted with respect to each hexagrid cell include indirect costs such as labor costs and fuel costs. In some embodiments equipment costs (e.g., depreciation, rental cost, etc.) may be included in economic input calculations.

The present techniques may compute the gross revenue of a given hexagrid by calculating per-hexagrid yield. The present techniques may compute net revenue for the hexagrid by subtracting the sum total of the economic inputs to the respective hexagrid. The gross revenue and net revenue of each hexagrid cell may be computed, resulting in a high-resolution profitability matrix with respect to a partitioned field.

Therefore, the present techniques advantageously improve over conventional techniques by providing growers, field managers and trusted advisors with high-resolution, granular information with respect to profitability that can also be used to compute aggregated statistics. Moreover, the present techniques advantageously improve over conventional techniques by allowing the decision-making personnel to spot patterns in the data by partitioning the high-resolution yield data, and to visualize the success or failure of the partitioned field grids. For example, a grower may immediately recognize upon seeing a path of unprofitable grid cells cutting a swath through a field that the respective grid cells correspond to an area with poor drainage, and that the addition of tiling is required. Such actionable information would be lost when the grower analyzes a field-level economic analysis, or a non-visual representation of more granular data.

The present techniques may be used to generate summary reports for growers, and to rank/compare hexagrid profitability across fields and across growers. Techniques such as environmental matching may be used to compare like growing areas, and/or to identify and remedy outlier areas. The present techniques include methods and systems for analyzing the high-resolution, granular economic analysis data generated to generate recommendations. For example, the recommendations may include human review of a region of a field (e.g., one or more hexagrid cells), abandonment/fallowing of the field or a portion thereof, adding or subtracting one or more agricultural inputs, etc.

### Exemplary Computing Environment

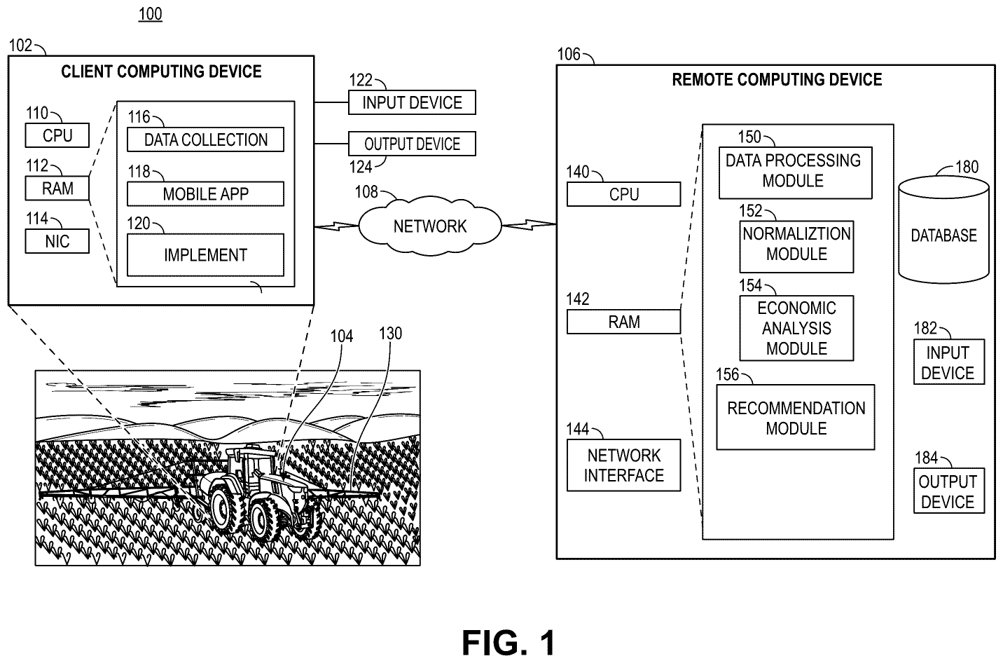

FIG. 1 depicts an exemplary computing environment 100 in which the techniques disclosed herein may be implemented, according to an embodiment.

The environment 100 includes a client computing device 102, an implement 104, a remote computing device 106, and a network 108. Some embodiments may include a plurality of client computing devices, remote computing devices and/or implements.

The client computing device 102 may be an individual server, a group (e.g., cluster) of multiple servers, or another suitable type of computing device or system (e.g., a collection of computing resources). For example, the client computing device 102 may be a mobile computing device (e.g., a server, a mobile computing device, a smart phone, a tablet, a laptop, a wearable device, etc.). In some embodiments the client computing device 102 may be a personal portable device of a user. In some embodiments the client computing device 102 may be temporarily or permanently affixed to the implement 104. For example, the client computing device 102 may be the property of a customer, an agricultural analytics (or “agrilytics”) company, an implement manufacturer, etc.

The client computing device 102 includes a processor 110, a memory 112 and a network interface controller (NIC) 114. The processor 110 may include any suitable number of processors and/or processor types, such as CPUs, one or more graphics processing units (GPUs), etc. Generally, the processor 110 is configured to execute software instructions stored in a memory 112. The memory 112 may include one or more persistent memories (e.g., a hard drive/solid state memory) and stores one or more set of computer executable instructions/modules, including a data collection module 116, a mobile application module 118, and an implement control module 120, as described in more detail below. More or fewer modules may be included in some embodiments. The NIC 114 may include any suitable network interface controller(s), such as wired/wireless controllers (e.g., Ethernet controllers), and facilitate bidirectional/multiplexed networking over the network 108 between the client computing device 102 and other components of the environment 100 (e.g., another client computing device 102, the implement 104, the remote computing device 106, etc.).

The one or more modules stored in the memory 112 may include respective sets of computer-executable instructions implementing specific functionality. For example, in an embodiment, the data collection module 116 includes a set of computer-executable instructions for collecting a machine data set from an implement (e.g., the implement 104). The data collection module 116 may include instructions for collecting an above-ground and/or below-ground soil sample.

The machine data collection module 116 may include a respective set of instructions for retrieving/receiving data from a plurality of different implements. For example, a first set of instructions may be for retrieving/receiving machine data from a first tractor manufacturer, while a second set of instructions is for retrieving/receiving machine data from a second tractor manufacturer. In another embodiment, the first and second set of instructions may be for, respectively, receiving/retrieving data from a tiller and a harvester. Of course, some libraries of instructions may be provided by the manufacturers of various implements and/or attachments, and may be loaded into the memory 112 and used by the data collection module 116. The data collection module 116 may retrieve/receive machine data from a separate hardware device (e.g., a client computing device 102 that is part of the implement 104) or directly from one or more of the sensors of the implement 104 and/or one or more of the attachments 130 coupled to the implement 104, if any.

The machine data may include any information generated by the client computing device 102, the implement 104 and/or the attachments 130. In some cases, the machine data may be retrieved/received via the remote computing device 106 (e.g., from a third-party cloud storage platform). For example, the machine data may include yield data generated by a harvester attachment 130 and/or a harvester implement 104. The machine data may include sensor measurements of crop yield, engine load data, fuel burn data, draft, fuel consumption, wheel slippage, gallons of water per minute, etc. In particular, the machine data may correspond to agricultural inputs of the grower, such as fungicide, macronutrient fertilizer, nitrogen, etc. The machine data may include one or more time series, such that one or more measured values are represented in a single data set at a common interval (e.g., one-second, five hertz, etc.). For example, the machine data may include a first time series of spray application in liters at a one-second interval, a second time series of fuel consumption per second, etc. In some embodiments, a non-common time interval may be reconciled between multiple time series through interpolation.

The machine data may be location-aware. For example, the client computing device 102 may add location metadata to the machine data, such that the machine data reflects an absolute and/or relative geographic position (i.e., location, coordinate, offset, heading, etc.) of the client computing device 102, the implement 104, and/or the attachments 130 within the agricultural field at the precise moment that the client computing device 102 captures the machine data. It will also be appreciated by those of ordinary skill in the art that some sensors and/or agricultural equipment may generate machine data that is received by the client computing device 102 that already includes location metadata added by the sensors and/or agricultural equipment. In an embodiment wherein the machine data comprises a time series, each value of the time series may include a respective geographic metadata entry. It will be further appreciate by those of ordinary skill in the art that when the machine data is received from a historical archive, the machine data may include historical location data (e.g., the GPS coordinates corresponding to the location from which the historical machine data was captured).

The data collection module 116 may receive and/or retrieve the machine data via an API through a direct hardware interface (e.g., via one or more wires) and/or via a network interface (e.g., via the network 108). The data collection module 116 may collect (e.g., pull the machine data from a data source and/or receive machine data pushed by a data source) at a predetermined time interval. The time interval may be of any suitable duration (e.g., once per second, once or twice per minute, every 10 minutes, etc.). The time interval may be short, in some embodiments (e.g., once every 10 milliseconds). The data collection module 116 may include instructions for modifying and/or storing the machine data. For example, the data collection module 116 may parse the raw machine data into a data structure. The data collection module 116 may write the raw machine data onto a disk (e.g., a hard drive in the memory 112).

In some embodiments, the data collection module 116 may transfer the raw machine data, or modified machine data, to a remote computing system/device, such as the remote computing device 106. The transfer may, in some embodiments, take the form of an SQL insert command. In effect, the data collection module 116 performs the function of receiving, processing, storing, and/or transmitting the machine data. The data collection module 116 may receive (e.g., from a soil probe attachment) soil sample data corresponding to one or more points within the machine data.

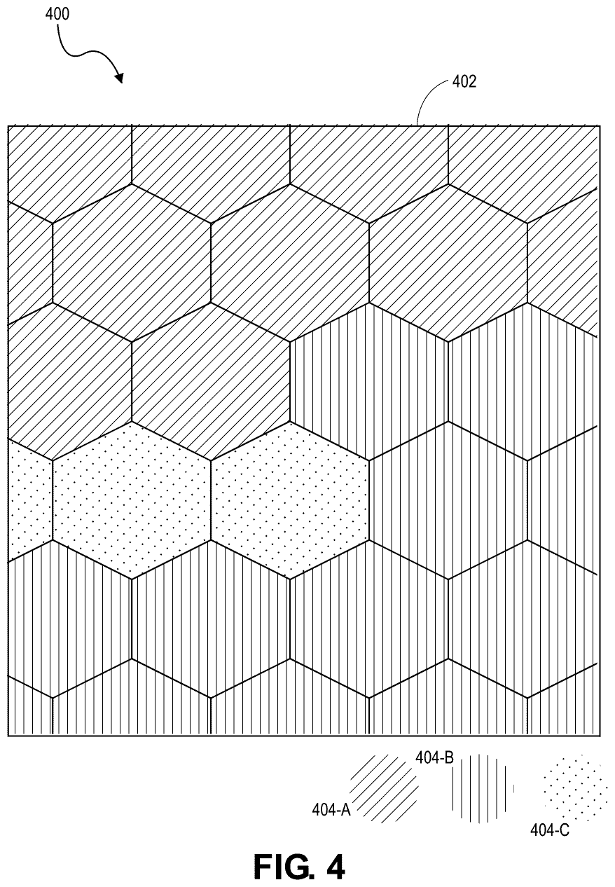

The mobile application module 118 may include computer-executable instructions that display one or more graphical user interfaces (GUIs) on the output device 124 and/or receive user input via the input device 122. For example, the mobile application module 118 may correspond to a mobile computing application (e.g., an Android, iPhone, or other) computing application of an agrilytics company. The mobile computing application may be a specialized application corresponding to the type of computing device embodied by the client computing device 102. For example, in embodiments where the client computing device 102 is a mobile phone, the mobile application module 118 may correspond to a mobile application downloaded for iPhone. When the client computing device 102 is a tablet, the mobile application module 118 may correspond to an application with tablet-specific features. Exemplary GUIs that may be displayed by the mobile application module 118, and with the user may interact, are discussed below. Specifically, FIG. 4 and related description describe several GUI embodiments that may be suitable for use within the mobile application module 118.

The mobile application module 118 may include instructions for receiving/retrieving mobile application data from the remote computing device 106. In particular, the mobile application module 118 may include instructions for transmitting user-provided login credentials, receiving an indication of successful/unsuccessful authentication, and other functions related to the user's operation of the mobile application. The mobile application module 118 may include instructions for receiving/retrieving, rendering, and displaying visual maps in a GUI. Specifically, the application module 118 may include computer-executable instructions for displaying one or more map layers in the output device 124 of the client computing device 102. The map layers may depict, for example, one or more hexagonal regions including but not limited to agricultural inputs, as applied data, yield data, etc. related to the agricultural field.

The implement control module 120 includes computer-executable instructions for controlling the operation an implement (e.g., the implement 104) and/or the attachments 130. The implement control module 120 may control the implement 104 while the implement 104 and/or attachments 130 are in motion (e.g., while the implement 104 and/or attachments 130 are being used in a farming capacity). For example, the implement control module 120 may include an instruction that, when executed by the processor 110 of the client computing device 102, causes the implement 104 to accelerate or decelerate, or measure the yield of the hexagrid within the field.

In some embodiments, the implement control module 120 may cause one of the attachments 130 to raise or lower the disc arm of a tiller, or to apply more or less downward or upward pressure on the ground. In some embodiments, the implement control module 120 may control the attachments 130 in response to the location in which the implement 130 is positioned. For example, when the present techniques have determined, as discussed below, that one or more hexagrids are not deserving of further mitigation to correct for low yields, the control module 120 may receive instructions from the recommendation module 156 to avoid applying any mitigating treatments. Practically, the implement control module 120 has all of the control of the implement 104 and/or attachments 130 as does the human operator. Further, the implement control module 120 is informed by the yield/net revenue computations of the environment 100 and other constraints imposed by the grower, agrilytics company, field manager, etc.

The implement control module 120 may include a respective set of instructions for controlling a plurality of implements. For example, a first set of instructions may be for controlling an implement of a first tractor manufacturer, while a second set of instructions is for controlling an implement of a second tractor manufacturer. In another embodiment, the first and second set of instructions may be for, respectively, controlling a tiller and a harvester. Of course, many configurations and uses are envisioned beyond those provided by way of example. In the present techniques, data cleaning and preprocessing is an important step for standardizing/normalizing data, as discussed below with respect to the normalization module 152. Thus, the implement control module 120 may include a library of translation functions for standardizing machine data received from implement 104 and/or from third-party sources (e.g., historical machine data).

In some embodiments, the implement control module 120 may include computer-executable instructions for executing one or more agricultural prescriptions with respect to a field. For example, the control module 120 may execute an agricultural prescription that specifies, for a given agricultural field, a varying application rate of a chemical (e.g., a fertilizer, an herbicide, a pesticide, etc.) or a seed to apply at various points within the field/hexagrid based on the spatial-economic characteristics of the field. The implement control module 120 may analyze the current location of the implement 104 and/or the attachments 130 in real-time (i.e., as the control module 120 executes the agricultural prescription).

In some embodiments, one or more components of the computing device 102 may be embodied by one or more virtual instances (e.g., a cloud-based virtualization service). In such cases, one or more client computing device 102 may be included in a remote data center (e.g., a cloud computing environment, a public cloud, a private cloud, etc.). For example, a remote data storage module (not depicted) may remotely store data received/retrieved by the computing device 102. The client computing device 102 may be configured to communicate bidirectionally via the network 108 with the implement 104 and/or an attachments 130 that may be coupled to the implement 104. The implement 104 and/or the attachments 130 may be configured for bidirectional communication with the client computing device 102 via the network 108.

The client computing device 102 may receive/retrieve data (e.g., machine data) from the implement 104, and/or the client computing device 102 may transmit data (e.g., instructions) to the implement 104. The client computing device 102 may receive/retrieve data (e.g., machine data) from the attachments 130, and/or may transmit data (e.g., instructions) to the attachments 130. The implement 104 and the attachments 130 will now be described in further detail.

The implement 104 may be any suitable powered or unpowered equipment/machine or machinery, including without limitation: a tractor, a combine, a cultivator, a cultipacker, a plow, a harrow, a stripper, a tiller, a planter, a baler, a sprayer, an irrigator, a sorter, an harvester, etc. The implement 104 may include one or more sensors (not depicted) including one or more soil probes and the implement 104 may be coupled to one or more attachments 130. For example, the implement 104 may include one or more sensors for measuring respective implement values of engine load data, fuel burn data, draft sensing, fuel consumption, wheel slippage, etc. Many embodiments including more or fewer sensors measuring more or fewer implement values are envisioned. The implement 104 may be a gas/diesel, electric, or hybrid vehicle operated by a human operator and/or autonomously (e.g., as an autonomous/driverless agricultural vehicle).

The attachments 130 may be any suitable powered or unpowered

equipment/machinery permanently or temporarily affixed/attached to the implement 104 by, for example, a hitch, yoke or other suitable mechanism. The attachments 130 may include any of the types of equipment that the implement 104 may comprise (e.g., a tiller). The attachments 130 may include one or more sensors (not depicted) that may differ in number and/or type according to the respective type of the attachments 130 and the particular embodiment/scenario. For example, a tiller attachment 120 may include one or more soil coring probes. It should be appreciated that many attachments 130 sensor configurations are envisioned. For example, the attachments 130 may include one or more cameras. The attachments 130 may be connected to the implement 104 via wires or wirelessly, for both control and communications. For example, attachments 130 may be coupled to the client computing device 102 of the implement 104 via a wired and/or wireless interface for data transmission (e.g., IEEE 802.11, WiFi, etc.) and main/auxiliary control (e.g., 7-pin, 4-pin, etc.). The client computing device 102 may communicate bidirectionally (i.e., transmit data to, and/or receive data from) with the remote computing device 106 via the network 108.

The client computing device 102 includes an input device 122 and an output device 124. The input device 122 may include any suitable device or devices for receiving input, such as one or more microphone, one or more camera, a hardware keyboard, a hardware mouse, a capacitive touch screen, etc. The output device 124 may include any suitable device for conveying output, such as a hardware speaker, a computer monitor, a touch screen, etc. In some cases, the input device 122 and the output device 124 may be integrated into a single device, such as a touch screen device that accepts user input and displays output. The client computing device 102 may be associated with (e.g., leased, owned, and/or operated by) an agrilytics company.

The network 108 may be a single communication network, or may include multiple communication networks of one or more types (e.g., one or more wired and/or wireless local area networks (LANs), and/or one or more wired and/or wireless wide area networks (WANs) such as the Internet). The network 108 may enable bidirectional communication between the client computing device 102 and the remote computing device 106, or between multiple client computing devices 102, for example.

The remote computing device 106 includes a processor 140, a memory 142 and a NIC 144. The processor 140 may include any suitable number of processors and/or processor types, such as CPUs and one or more graphics processing units (GPUs). Generally, the processor 140 is configured to execute software instructions stored in the memory 142. The memory 142 may include one or more persistent memories (e.g., a hard drive/solid state memory) and stores one or more set of computer executable instructions/modules, as discussed below. For example, the remote computing device 106 may include a data processing module 150, a topographic module 152, a mineral composition module 154, a clay characterization module 156, and a prescription module 158. The NIC 144 may include any suitable network interface controller(s), such as wired/wireless controllers (e.g., Ethernet controllers), and facilitate bidirectional/multiplexed networking over the network 106 between the remote computing device 106 and other components of the environment 100 (e.g., another remote computing device 106, the client computing device 102, etc.).

The one or more modules stored in the memory 142 may include respective sets of computer-executable instructions implementing specific functionality. For example, in an embodiment, the data processing module 150 includes computer-executable instructions for receiving/retrieving data from the client computing device 102, the implement 104, and/or the attachments 130. For example, the data processing module 150 may include instructions that when executed by the processor 140, cause the remote computing device 106 to receive/retrieve machine data. The data processing module 150 may include further instructions for storing the machine data in one or more tables of the database 180. The data processing module 150 may store raw machine data, or processed data.

The data processing module 150 may include instructions for processing the raw machine data to generate processed data. For example, the processed data may be data that is represented using data types data of a programming language (e.g., R, C#, Python, JavaScript, etc.). The data processing module 150 may include instructions for validating the data types present in the processed data. For example, the data processing module 150 may verify that a value is present (i.e., not null) and is within a particular range or of a given size/structure. In some embodiments, the data processing module 150 may transmit processed data from the database 180 in response to a query, or request, from the client computing device 102. The data processing module 150 may transmit the processed data via HTTP or via another data transfer suitable protocol. The data processing module 150 may source elevation data from public sources, such as the United States Geological Survey (USGS) National Elevation Dataset (NED) database. In some embodiments, the data processing module 150 may provide raw data to other modules, wherein instructions within the topographic module 152 infer the elevation of a particular plot of land by analyzing the raw data. The elevation data may be stored in a two-dimensional (2D) or three-dimensional (3D) data format, depending on the embodiment and scenario.

The normalization module 152 may include instructions for standardizing/normalizing values within the machine data. For example, the normalization module 152 may convert rate application information from multiple distinct equipment manufacturers into a comparable value. A first implement may generate rate application information in thousands, while a second implement generates rate application information in tens. As a simple example, the normalization module may harmonize the two values to the thousands place so that they may be compared. In some embodiments, the normalization module 152 may modify values by, for example, converting data types (e.g., from strings to integers). It will be appreciated by those of ordinary skill in the art that the examples of normalization provided herein are simplified for expository purposes, and that many further uses are envisioned.

The economic analysis module 154 may include instructions for computing the total and individual costs of agricultural inputs as discussed herein. The economic analysis module 154 may include instructions for computing crop yields, gross revenue, net revenue and other economic statistics at the hexagrid, field and/or farm levels. The economic analysis module 154 may include instructions for calculating yields based on real-time market data, so as to provide the most up-to-date and relevant economic statistics. The economic analysis module 154 may include instructions for calculating inflation and interest rates with respect to the cost of agricultural inputs. The economic analysis module 154 may receive/retrieve econometric data from the database 180 and/or third-party application programming interfaces.

The economic analysis module 154 may include instructions for generating interactive economic analysis reports. The economic analysis report may be a digital file (e.g., a PDF, a text document, a presentation, an interactive document/workbook, etc.). The economic analysis module 154 may store the economic analysis report in the database 180 and/or on in the memory 142. The economic analysis module 154 may include information in the economic analysis report drawn from other sources, for example, from the recommendation module 156.

The recommendation module 156 may include instructions for computing recommendations using information generated by the economic analysis module 154 and/or as-applied data (e.g., machine data, historical machine data, etc.). For example, the recommendation module 156 may analyze net revenue exclusive of indirect agricultural inputs (e.g., excluding fuel costs, equipment rental costs, etc.). The recommendation module may include one or more trained machine learning model, in some embodiments, for generating predictions. Specifically, the recommendation module 156 may include a machine learning model trained using labeled yield data and revenue data. The recommendation module 156 may input net revenue and as-applied data with respect to a single hexagrid into the machine learning model to generate a recommendation. In some embodiments, the recommendation may include a treatment and/or a predicted revenue increase. For example, the machine learning model may indicate that applying a nitrogen stabilizer is predicted to increase revenue by 6%.

The remote computing device 106 may further include one or more databases 180, an input device 182, and an output device 184. The database 180 may be implemented as a relational database management system (RDBMS) in some embodiments. For example, the data store 180 may include one or more structured query language (SQL) databases, a NoSQL database, a flat file storage system, or any other suitable data storage system/configuration. In general, the database 180 allows the client computing device 102 and/or the remote computing device 106 to create, retrieve, update, and/or retrieve records relating to performance of the techniques herein. For example, the database 180 may allow the client computing device 102 to store information received from one or more sensors of the implement 104 and/or the attachments 130. The database 180 may include a Lightweight Directory Access Protocol (LDAP) directory, in some embodiments. The client computing device 102 may include a module (not depicted) including a set of instructions for querying an RDBMS, an LDAP server, etc. For example, the client computing device 102 may include a set of database drivers for accessing the database 180 of the remote computing device 106. In some embodiments, the database 180 may be located remotely from the remote computing device 104, in which case the remote computing device 104 may access the database 180 via the NIC 112 and the network 106.

The input device 182 may include any suitable device or devices for receiving input, such as one or more microphones, one or more cameras, a hardware keyboard, a hardware mouse, a capacitive touch screen, etc. The input device 182 may allow a user (e.g., a system administrator) to enter commands and/or input into the remote computing device 106, and to view the result of any such commands/input in the output device 184. For example, an employee of the agrilytics company may use the input device 182 to explore view machine data sets normalized by the normalization module 152.

The output device 184 may include any suitable device for conveying output, such as a hardware speaker, a computer monitor, a touch screen, etc. The remote computing device 106 may be associated with (e.g., leased, owned, and/or operated by) an agrilytics company. As noted above, the remote computing device 106 may be implemented using one or more virtualization and/or cloud computing services. One or more application programming interfaces (APIs) may be accessible by the remote computing device 106.

In operation, the agrilytics company may access the remote computing device 106 to establish one or more field records on behalf of one or more growers. For example, the company may store the field records in the database, wherein each grower is associated with a unique identifier (e.g., a universally unique identifier (UUID)) as are each of the grower's respective fields. For example, the grower may be associated with the grower's fields in the database via a one-to-many relationship.

The agrilytics company may populate the database 180 with machine data corresponding to the grower's fields by using the implement 104 to drive the fields and collect the machine data. The machine data may include information gathered from an attachment 130 (e.g., a soil probe) and/or machine data collected from other sources. In some embodiments, the remote computing device 106 may populate the database 180 with machine data stored elsewhere (e.g., in a third-party computing cloud). Once the machine data for the grower's fields has been collected, the machine data may be assigned to field partitions (e.g., hexagrids) as discussed herein. The assignment of machine data to hexagrids may be performed by the data processing module 150, in some embodiments, and may use location data collected from a GPS unit of the client computing device 102 and/or location data included in the machine data from a third-party source. The process of collecting the machine data may include the normalization module 152 processing the data to normalize all values therein, to make similar data from multiple implement manufacturers and/or makes/models directly comparable.

Once the machine data is collected, normalized and assigned to partitioned fields, the economic analysis module may analyze the machine data to determine the agricultural inputs corresponding to each hexagrid. The analysis may include dividing a proportion of the agricultural inputs for a field across all hexagrids belonging to that field, in some embodiments. In some embodiments as-applied data may be analyzed to determine the agricultural inputs used for each hexagrid, using location data. The economic analysis module 154 may compute economic statistics (e.g., gross revenue, net revenue, etc.) for the hexagrid that may include/exclude direct costs. The net revenue and as-applied data may be further analyzed by the recommendation module 156 to generate predictions for improving profitability and for the generation of economic analysis reports. The predictions for improved profitability and/or economic analysis reports may be provided to the user via the network 108 and the client computing device 102.

In some embodiments, the user may interact with the economic analysis reports via the mobile application 118. In some embodiments, the economic analysis module 154 may compute aggregate statistics using the individual hexagrid yield, agricultural input costs, and revenues. The aggregate statistics may be included in the economic analysis reports. Thus, the economic analysis reports may include an overall field profitability summary, as well as field-by-field and hexagrid-by-hexagrid economic breakdowns. The economic analysis module 154 may include instructions for computing mathematical averages, minimums, maximums, standard deviations, etc. that may be useful in informing the user as to the performance of the farming operation.

The remote computing device 106 may generate one or more spatial map layers that may include partitioned field data. The spatial map layers may be transmitted to the client computing device 102 and displayed by the mobile application 118 in the output device 124. A grower may view the spatial map layers in an application of the agrilytics company (e.g., Senio) while tending to a field, and/or offline. In some embodiments, the remote computing device 106 may generate and transmit agricultural prescriptions based on the recommendations generated by the recommendation module 156. The remote computing device 106 may transmit the prescriptions to the implement control module 120 of the client computing device 102. The implement control module 120 may execute the prescriptions for controlling the actions of the implement 104. In this way, the recommendations may be directly carried out in an automated fashion. It should be appreciated that the examples provided are intentionally simplified for explanation, and many further embodiments are envisioned, as described below.

### Exemplary Field Partitioning and As-Applied Data Standardization

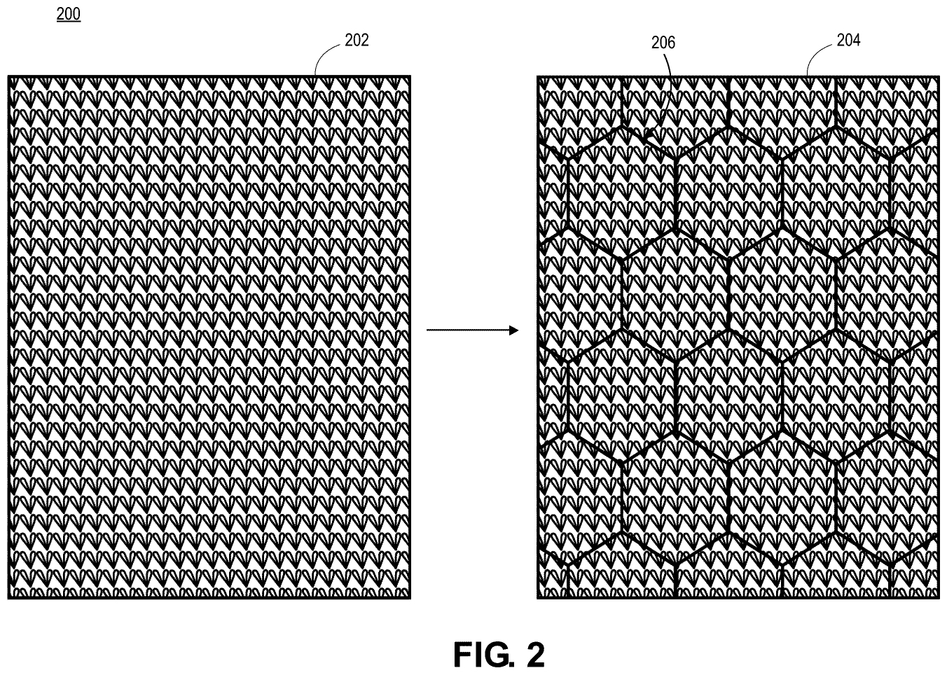

FIG. 2 depicts an exemplary environment 200 depicting partitioning of an agricultural field 202 into a partitioned field 204 using a plurality of hexagonal grid cells 206, or hexagrids, according to an embodiment. The field 200 may be any suitable field for growing a crop. The crop may be, for example, a cereal crop (e.g., corn, wheat, rice, etc.) a tuber crop (e.g., sweet potato), a vegetable crop (e.g., onion, tomato, etc.), a fruit crop (e.g., mangoes, grapes, etc.). The crop may include an above-ground portion and/or a below-ground portion.

It will be appreciated by those of ordinary skill in the art that the hexagonal partitioning of the partitioned field 204 (e.g., the hexagrids 206) represents an advantageous improvement over the conventional practice of partitioning fields using rectangular grid cells. Specifically, hexagons tile more neatly than squares, such that hexagonal tessellations are able to divide a surface into regions of equal area with the least total perimeter. In mathematics, this property is known as the honeycomb conjecture. Practically speaking, this means that in a field of a given size (e.g., 80 acres) more hexagonal cells may be fit than rectangular cells.

In some embodiments, the present techniques may partition the field 200 by creating a copy of the field 200 (i.e., the partitioned field 202). The field 200 may be represented as a map layer (e.g., a shape file), in some embodiments. The present techniques may include creating a copy of the shape file, and adding another layer that includes the hexagrids 206. In some embodiments, the present techniques may partition the map layer corresponding to the field 200 without creating a copy, by adding the hexagrids 206 to an existing shape file. The data processing module 150 of FIG. 1 may perform the partitioning, in some embodiments.

The present techniques may further include standardizing as-applied data and/or machine data with respect to the field partitioning of the partitioned field 204, in some embodiments. Standardizing the field 200 by partitioning the field into the partitioned field 204 introduces several improvements over conventional techniques. The normalization module 152 may perform the standardization, in some embodiments.

Standardization enables the as-applied data and/or machine data to be harmonized, for example, irrespective of output rate. Different growers may use different implements (e.g., a first grower may use an implement 104 manufactured by a first manufacturer whereas a second grower uses an implement 104 manufactured by a second manufacturer). Therefore, as-applied data received/retrieved from each implement may differ significantly, and generate non-standardized data. Even a single manufacturer's implements of different vintage, version, model etc. may generate very different as-planted data.

An example of non-standardized data is found in implement output interval. A first implement may generate row-by-row as-applied data at 5 hertz (e.g., 0.2 seconds (period)). Over a 100-acre field, such an implement may generate millions of data points that must be segmented and associated with the hexagrids 206. The present techniques may include methods and systems for performing such assignment by spatial analysis, wherein points defined within the boundary of each respective hexagrid are assigned to that hexagrid. The spatial assignment may be the same, but the standardization process may take into account the differing output rates of the multiplicity of implements in use. Therefore, a second advantage of the present techniques over conventional techniques is in enabling allows large data sets to be effectively managed, regardless of origin.

In another example, equipment manufacturers may not report attributes consistently. For example, a first implement may report seed drop rate (e.g., rate of seeds dropped per acre) as 32,000 seeds. Another implement may assume that the integer value is in the thousands. Without standardizing such outputs, the resulting analysis between fields using different implements would range from the low tens to the tens of thousands, severely skewing any statistical analysis. Therefore, a third advantage of the present standardization techniques over conventional techniques is to enable back-end analysis to be performed on-demand, without the need to first fix or clean data or, worse, spend time attempting to determine why collected as-applied data sets do not make sense in relation to one another.

Once the present techniques have converted the field 200 to the partitioned field 204, and associated as-applied data to the partitioned field 204, the partitioned field 204, the hexagrids 206 and the as-applied data as associated with each respective hexagrid of the hexagrids 206 may be stored. For example, the data processing module 150 and/or the normalization module 152 of FIG. 1 may store the partitioned field 204 in the database 180 of FIG. 1, or the memory 142 of FIG. 1. The partitioned field 204 and hexagrids 206 may be stored as spatial map files/layers (e.g., shapefiles). The stored spatial map files may be retrieved, queried and/or transmitted via the network 108. The spatial map files may be displayed, via the output device 184 of the remote computing device 106 and/or in the output device 124 of FIG. 1.

### Exemplary Hexagrid Input/Output Analysis

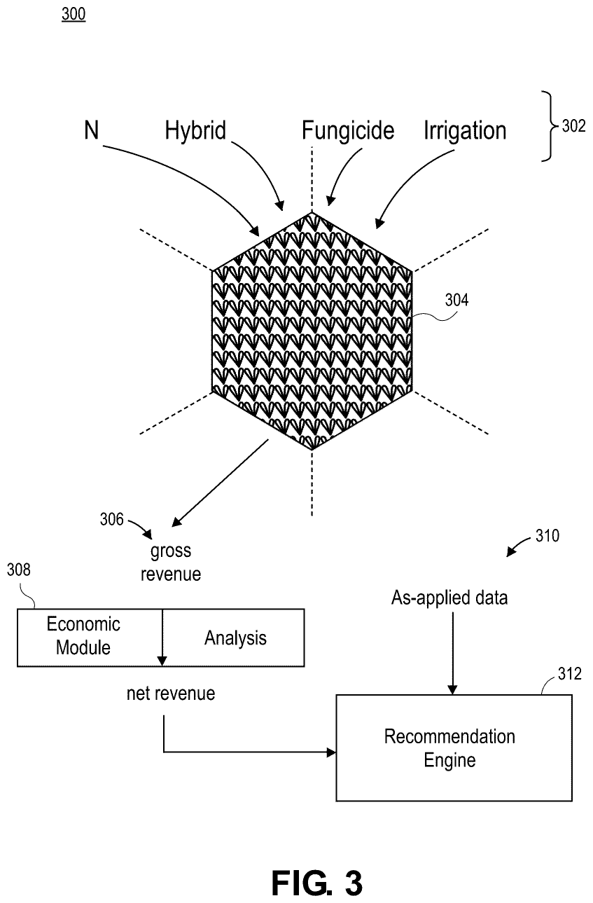

FIG. 3 depicts an exemplary combination data flow and block diagram 300 depicting collecting agricultural inputs 302 with respect to a hexagrid 304. FIG. 3 further depicts computing a gross revenue 306 with respect to the hexagrid 304 and analyzing the gross revenue using an economic analysis module 308 to determine a net revenue. FIG. 3 further depicts analyzing the net revenue and as-applied data 310 using a recommendation engine 312 to generate one or more field management recommendations.

As discussed above, the agricultural inputs 302 may be economic inputs to the hexagrid 304 and may include both direct costs (e.g., treatments) and indirect costs (e.g., labor and fuel). The hexagrid 304 is exemplary of any of the hexagrids 206 of FIG. 2. In other words, the agricultural inputs 302 may be calculated independently for each of the hexagrids 206. The gross revenue 306 may be equal to the total economic value of the yield created by the hexagrid. The yield of the hexagrid may be measured by any suitable method (e.g., by sampling, by random sampling, by grower estimation, by machine data reporting from an implement such as a harvester, etc.). Once the yield is known, or capable of estimation, the market value/gross revenue of the hexagrid 306 may be determined by multiplying the yield by a spot price, a future price, etc.

The economic analysis module 308, which may correspond to the economic analysis module 154 of FIG. 1, may analyze the gross revenue 306 to compute a net revenue for the hexagrid. The computation of the net revenue may include subtracting the economic inputs 302 from the gross revenue 306. The net revenue may be provided, along with the as-applied data 310, to the recommendations engine 312.

In some embodiments, the recommendations engine 312 may be implemented by the recommendations module 156 of FIG. 1. The recommendations engine 312 advantageously provides improvements over conventional techniques by automating the analysis of large amounts of data that may be generated using the present techniques. For example, in a growing operation with 20,000 acres, many (e.g., one million or more) hexagrid cells 304 may be separately analyzed, generating one million net revenue computations. In most cases, this is an information overload that the grower and trusted advisor will struggle to make sense of. Therefore, the present techniques include analyzing the output of the hexagrid cell 304 across all acres.

In reality, some farms are farmed for little to no profit margin. Growers struggle to understand how to deploy strategies to increase production or to increase profit margin while reducing agricultural inputs. As noted, conventional techniques do not provide granularity sufficient to allow the grower to identify those portions of the grower's fields that are less economically viable. Therefore, the recommendations engine 312 may include instructions for analyzing the net revenue of a plurality of hexagrid cells 304, in addition to as-planted data to determine, for example, the hexagrids 304 that may be worthy of further agricultural inputs. The recommendations engine 312 may include rule sets for analyzing the net revenue and as-applied data 310. An example rule may identify the cells having the highest cost and lowest net revenue. By doing so, the rule sets are able to identify the cells least likely to increase the overall profitability of the field. It will be appreciated by those of ordinary skill in the art that many additional rules are envisioned. As noted, the recommendations engine 312 may include instructions for comparing multiple fields. One such comparison may analyze net revenue variance across fields that are identified as environmentally similar using an environmental matching analysis.

Another appreciable benefit of the present techniques over conventional methodologies is providing the end user (whether grower, trusted advisor, field manager, etc.) with visualizations that may be used to spot problems and/or prosperous areas of the field.

### Exemplary Graphical User Interface Data Visualization Embodiments

One of the nuances for growers and field managers alike is knowing when a particular field should be left alone. Leaving a field alone may mean not intervening with portions of a field (e.g., hexagrids) that are successful (e.g., have relatively high net revenue, compared to other hexagrids within the field or those with similar environmental characteristics elsewhere). For example, it may be economically preferable in some cases to avoid treating saturated areas with nitrogen stabilizer when to do so may cost more than any potential gain in net revenue. As such, the present techniques advantageously improve over conventional methodologies by enabling the end user to visualize net revenue at a sub-field (i.e., hexagrid) level.

FIG. 4 depicts an exemplary graphical user interface 400 including a partitioned field 402, subdivided into hexagrid cells denoting economic profitability, according to an embodiment. For example, the partitioned field 402 may correspond to the partitioned field 204 of FIG. 2. The partitioned field 402 includes a first region 404-A, a second region 404-B and a third region 404-C. Each of the regions 404 may correspond to a respective set of hexagrids grouped by net revenue (e.g., rounded to the nearest five dollars).

Continuing the example, the first region 404-A may correspond to an area wherein each hexagrid includes net revenue of $2000-$4000. The second region 404-B may correspond to an area wherein each hexagrid includes net revenue of $4000-$6000. The third regions 404-C may correspond to an area wherein each hexagrid includes net revenue of $500-$1000. Immediately, presenting the net revenue statistics generated by the present techniques in a visual format raises several essential observations for the grower, field manager and trusted advisor. For example, these personnel may seek to understand why the region 404-A has been more successful than the region 404-A. Determining the differences may be assisted by input capabilities of the present techniques.

The graphical user interface 400 may be displayed in a device of the user, such as the mobile application 118 of the client computing device 102. The user may select one or more of the hexagrids (e.g., via a touch screen interface via the input device 122/output device 124). In response to selecting one of the hexagrids, the mobile application 118 may display statistics (e.g., as applied data of the hexagrid, gross revenue of the hexagrid, agricultural inputs of the hexagrid, historical weather related to the hexagrid, etc.) in the graphical user interface 400 for the user's review. Therefore, when the user wants to compare net revenue, the user can also quickly view the aspects of the growing cycle that may have ultimately affected net revenue.

Furthermore, when the user questions why the region 404-C corresponds to a relatively low net revenue, the user may explore the same statistical data. However, in some cases, the statistics alone may not persuade the user, or provide sufficient information for the user to reach a conclusion. Therefore, the user may add further map layers, such as a topographical map layer, showing elevation. Or a map layer showing wells, irrigation ditches and drainage areas. In so doing, the user may notice, for example, that the region 404-C includes an irrigation system but lacks drainage tiles. Thus, the knowledgeable field manager may be able to immediately suggest to the grower a remedy, including adding drainage tiles to the region 404-C.

In some embodiments, the graphical user interface 400 may include aspects that allow a user to add simulated drainage tiles to one or more of the hexagrids depicted in the partitioned field 402, to estimate the cost of adding the drainage tiles. In another embodiment, the graphical user interface may include functionality for allowing the user simulate adding nitrogen stabilizer to the selected hexagrid. The user can then determine an expected increase in net revenue, in light of the cost of adding the nitrogen.

In some embodiments, the mobile application 118 may include instructions for estimating the improvement in net revenue when drainage or other mitigation steps are taken, allowing the user to determine whether such mitigation is worth doing, or whether some of the hexagrids should not be planted in an upcoming season. Therefore, the present techniques assist those involved in agricultural decision-making to make the otherwise difficult decisions discussed above, of knowing when a field should not be planted, used for another purpose (e.g., grazing of livestock), enrolled in a conservation reserve program (CRP), etc. The examples provided herein have been simplified for expository purposes, but those of ordinary skill in the art will appreciate the many potential uses of such visualization techniques.

### Exemplary Computer-Implemented Method

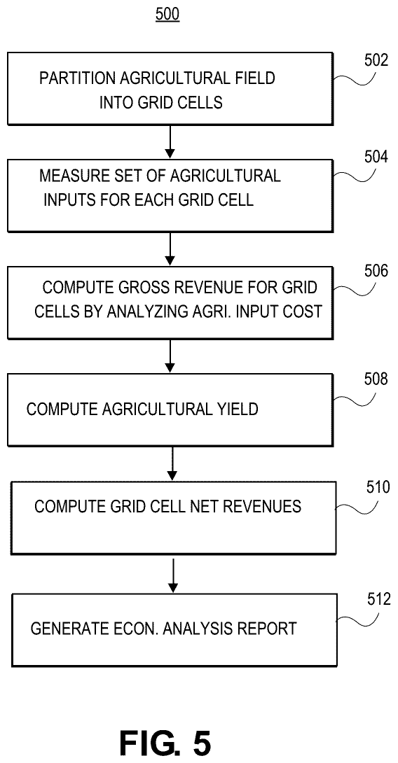

FIG. 5 depicts an exemplary computer-implemented method 500 for providing a high-resolution economic analysis of a partitioned agricultural field, according to one embodiment and scenario.

The method 500 may include partitioning the agricultural field into grid cells (block 502). The partitioning may include tiling the field using hexagonal shapes (e.g., 8.5-meter hexagrids) as depicted in FIG. 2, FIG. 3 and FIG. 4. As noted, the partitioned agricultural field may be represented using a shapefile or other spatial digital file, and stored in a suitable location. The shapefile may include one or more layers that may be displayed in the client computing device 102 of FIG. 1, for example. For example, the partitioned field may be displayed in the graphical user interface 400 to allow the user to vie the economic

The method 500 may include measuring a set of agricultural inputs for each of the respective grid cells (block 504). Specifically, as shown in FIG. 3, the present techniques may include determining a set of agricultural inputs 302 that are specific to the grid cell 304, in an example. Each grid cell in a field may be associated with a unique set of agricultural inputs 302.

The method 500 may include computing a gross revenue for each of the respective grid cells by analyzing the respective cost of agricultural inputs (block 506). The gross revenue may correspond to the gross revenue 306 of FIG. 3, in some embodiments. The gross revenue may be computed by the economic analysis module 154 of FIG. 1, for example. In some embodiments, the gross revenue may be determined using market data (e.g., spot/future prices of a commodity).

The method 500 may include computing an agricultural yield for each of the respective grid cells (block 508). The agricultural yield may correspond to the amount of marketable crop grown in within the respective grid cell. Yield may be determined by analyzing machine data, in some embodiments. Specifically, each point within a spatial field may be associated with a yield. The method 500 may include summing the yield within machine data corresponding to all points within a grid cell, or hexagrid, to determine the total yield for that hexagrid.

The method 500 may include computing a net revenue for each of the respective grid cells (block 510). As discussed net revenue is generally defined as the gross revenue less the cost of direct and/or indirect agricultural inputs. In some embodiments, the method 500 may include computing a direct net revenue and indirect net revenue. The method 500 may provide the indirect net revenue and the direct net revenue to the recommendation engine 312 of FIG. 3, for example. In other words, the recommendation module 156 of FIG. 1 may receive different revenue figures from the economic analysis module 154, and may base predictions/recommendations on the different revenues. For example, in an embodiment, the cost of fuel may not be relevant to an analysis and is best excluded as part of the indirect net revenues (e.g., when a solar-powered implement 104 is used for planting/harvest).

The method 500 may include generating an economic analysis report including the gross revenue, the agricultural yield and the net revenue for each of the respective grid cells (block 512). The economic analysis report may be an electronic document that ranks fields according to net revenue, for example. The rules discussed above may be used to identify those hexagrids that are good candidates for an increase in agricultural input or a reduction in agricultural input, relative to other hexagrids. The economic analysis module 154 of FIG. 1 may generate the economic analysis report, in some embodiments.

In some embodiments, the recommendation module 156 may generate recommendations that are included in the economic analysis report. For example, the recommendation module 156 may determine that no practical amount of nitrogen stabilizer (e.g., by reference to a threshold) will be sufficient to increase profitability of certain hexagrids beyond a break-even point. In such cases, the economic analysis report may include a section recommending exclusion of such hexagrids from further planting. Similarly, the recommendation module 156 may include a rule such that when a percentage of non-viable hexagrids within a field is reached (e.g., 17% or more), the field is considered wholly excluded. Such wholesale exclusion of fields on the basis of a predetermined plurality percentage of hexagrids being non-viable for planting/harvest may be reflected in the digital economic analysis report provided by the agrilytics company to the grower. The method 500 may generate the economic analysis at any suitable frequency (e.g., hourly, daily, weekly, etc.) and may transmit (e.g., via email) the client computing device 102 for display to the end user.

### ADDITIONAL CONSIDERATIONS

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computer-implemented method for providing a high-resolution analysis of an agricultural field, comprising:
partitioning, via one or more processors, the agricultural field into hexagonal grid cells;
measuring, via one or more processors, a set of agricultural inputs for each of the respective grid cells,
wherein the set of agricultural inputs includes both direct costs and indirect costs; receiving, via one or more processors, market data corresponding to a crop planted on the agricultural field;
computing, via one or more processors, an agricultural yield for each of the respective grid cells;
computing, via one or more processors, a gross revenue for each of the respective grid cells by analyzing a respective cost of each of the agricultural inputs, the market data and the respective agricultural yield of each of the respective grid cells;
computing, via one or more processors, a net revenue for each of the respective grid cells by subtracting at least the direct costs and the indirect costs from the respective gross revenue;
in response to receiving a user selection of one or more of the grid cells via a graphical user interface, generating, via one or more processors, an analysis report including the gross revenue, the agricultural yield, and the net revenue for each of the respective selected grid cells,
wherein the generating includes processing the respective selected grid cells using a machine learning model trained using labeled yield data and revenue data to generate one or more recommendations, each corresponding to a respective one of the respective grid cells; and
transmitting the analysis report to a computing device for display to the user,
wherein the analysis report includes recommendations for adding or subtracting one or more agricultural inputs based on the net revenue and as-applied data of the respective grid cells.

2. The computer-implemented method of claim 1, wherein measuring the set of agricultural inputs for each of the respective grid cells includes receiving as-applied data from an agricultural implement.

3. The computer-implemented method of claim 2, further comprising:
standardizing the as-applied data from the agricultural implement.

4. The computer-implemented method of claim 1, further comprising:
displaying a plurality of the grid cells in a graphical user interface, and
causing, in response to a user selection of one of the plurality of grid cells, at least one of the set of agricultural inputs, the gross revenue, the agricultural yield, and the net revenue corresponding to the selected one of the plurality of grid cells to be displayed in the graphical user interface.

5. The computer-implemented method of claim 1, further comprising:
determining, based on the respective net revenue of a plurality of the grid cells of the agricultural field, that the agricultural field should not be planted.

6. The computer-implemented method of claim 1, further comprising:
analyzing the respective set of agricultural inputs, the respective agricultural yield and the respective net revenue to determine a recommendation for improving profitability of the grid cells.

7. A computing system for providing a high-resolution analysis of an agricultural field, comprising:
one or more processors; and
one or more memories storing instructions that, when executed by the one or more processors, cause the computing system to:
partition the agricultural field into hexagonal grid cells;
measure a set of agricultural inputs for each of the respective grid cells,
wherein the set of agricultural inputs includes both direct costs and indirect costs;
receive market data corresponding to a crop planted on the agricultural field;
compute an agricultural yield for each of the respective grid cells;
compute a gross revenue for each of the respective grid cells by analyzing a respective cost of each of the agricultural inputs, the market data and the respective agricultural yield of each of the respective grid cells;
compute a net revenue for each of the respective grid cells by subtracting at least the direct costs and the indirect costs from the respective gross revenue;
generate an analysis report including the gross revenue, the agricultural yield, and the net revenue for each of the respective selected grid cells by processing the respective selected grid cells using a machine learning model trained using labeled yield data and revenue data to generate one or more recommendations, each corresponding to a respective one of the respective grid cells; and
transmit the analysis report to a computing device for display to the user,
wherein the analysis report includes recommendations for adding or subtracting one or more agricultural inputs based on the net revenue and as-applied data of the respective grid cells.

8. The computing system of claim 7, the one or more memories including further instructions that, when executed by the one or more processors, cause the computing system to:
receive as-applied data from an agricultural implement.

9. The computing system of claim 8, the one or more memories including further instructions that, when executed by the one or more processors, cause the computing system to:
standardize the as-applied data from the agricultural implement.

10. The computing system of claim 7, the one or more memories including further instructions that, when executed by the one or more processors, cause the computing system to:
display a plurality of the grid cells in a graphical user interface, and
cause, in response to a user selection of one of the plurality of grid cells, at least one of the set of agricultural inputs, the gross revenue, the agricultural yield, and the net revenue corresponding to the selected one of the plurality of grid cells to be displayed in the graphical user interface.

11. The computing system of claim 7, the one or more memories including further instructions that, when executed by the one or more processors, cause the computing system to:
determine, based on the respective net revenue of a plurality of the grid cells of the agricultural field, that the agricultural field should not be planted.

12. The computing system of claim 7, the one or more memories including further instructions that, when executed by the one or more processors, cause the computing system to:
analyze the respective set of agricultural inputs, the respective agricultural yield and the respective net revenue to determine a recommendation for improving profitability of the grid cells.

13. A non-transitory computer readable medium containing program instructions that when executed, cause a computer to:
partition the agricultural field into hexagonal grid cells;
measure a set of agricultural inputs for each of the respective grid cells,
wherein the set of agricultural inputs includes both direct costs and indirect costs;
receive market data corresponding to a crop planted on the agricultural field;
compute an agricultural yield for each of the respective grid cells;
compute a gross revenue for each of the respective grid cells by analyzing a respective cost of each of the agricultural inputs, the market data and the respective agricultural yield of each of the respective grid cells;
compute a net revenue for each of the respective grid cells by subtracting at least the direct costs and the indirect costs from the respective gross revenue;
generate an analysis report including the gross revenue, the agricultural yield, and the net revenue for each of the respective selected grid cells by processing the respective selected grid cells using a machine learning model trained using labeled yield data and revenue data to generate one or more recommendations, each corresponding to a respective one of the respective grid cells; and
transmit the analysis report to a computing device for display to the user,
wherein the analysis report includes recommendations for adding or subtracting one or more agricultural inputs based on the net revenue and as-applied data of the respective grid cells.

14. The non-transitory computer readable medium of claim 13, containing further program instructions that when executed, cause a computer to:
receive as-applied data from an agricultural implement.

15. The non-transitory computer readable medium of claim 14, containing further program instructions that when executed, cause a computer to:
standardize the as-applied data from the agricultural implement.

16. The non-transitory computer readable medium of claim 13, containing further program instructions that when executed, cause a computer to:
display a plurality of the grid cells in a graphical user interface, and
cause, in response to a user selection of one of the plurality of grid cells, at least one of the set of agricultural inputs, the gross revenue, the agricultural yield, and the net revenue corresponding to the selected one of the plurality of grid cells to be displayed in the graphical user interface.

17. The non-transitory computer readable medium of claim 13, containing further program instructions that when executed, cause a computer to:
determine, based on the respective net revenue of a plurality of the grid cells of the agricultural field, that the agricultural field should not be planted.
